(19) United States
(12) Patent Application Publication
(10) Pub. No.: US 2002/0054986 A1
(43) Pub. Date: May 9, 2002

(54) Foamed molding

(76) Inventors: Takashi Koike, Gunma (JP); Kouji Akasaka, Gunma (JP)

Correspondence Address: ARENT FOX KINTNER PLOTKIN & KAHN, PLLC, Suite 400, 1050 Connecticut Avenue, N.W., Washington, DC, 20036-5339, US

(21) Appl. No.: 09/978,842

(22) Filed: Oct. 18, 2001

(30) Foreign Application Priority Data
Oct. 19, 2000 (JP) 2000-319162

(51) Int. Cl. B32B 3/26

(52) U.S. Cl. 428/304.4

(57) ABSTRACT

A foamed molding includes a skin layer formed by cooling and solidifying a foamable synthetic resin that has been injected into a cavity and a foamed layer formed within the skin layer by foaming the foamable synthetic resin after the skin layer has been formed, wherein a rod-like connector section that connects together parts of the skin layer that correspond to each other is formed integrally with the skin layer, the foamed layer being interposed between the parts of the skin layer. It is thereby possible to maintain the product dimensions even when the foamable synthetic resin foams further after molding in the mold device is completed.

### BACKGROUND OF THE INVENTION

1. Field of the Invention

The present invention relates to a foamed molding and, in particular, to an improvement in a foamed molding comprising a skin layer formed by cooling and solidifying a foamable synthetic resin that has been injected into a cavity and a foamed layer formed within the skin layer by foaming the foamable synthetic resin after formation of the skin layer.

2. Description of the Related Art

Such a foamed molding is known in, for example, Japanese Patent Application Laid-open No. 8-90599.

When molding a foamed molding, a hard skin layer is formed by cooling and solidifying that portion of a foamable thermoplastic synthetic resin in contact with a mold device whose cavity it has been injected into and a foamed layer is then formed by moving a part of the mold so as to increase the capacity of the cavity and thereby reduce its pressure, which allows the unhardened synthetic resin within the skin layer to foam, to give a foamed molding having the foamed layer within the skin layer.

However, the foamable synthetic resin foams further even after the foamed molding is removed from the mold device, and as a result the foamed layer might expand and exceed a desired size. In such a case, the above-mentioned arrangement cannot maintain the product dimensions of the foamed molding, and it might become difficult to assemble the foamed molding to other components.

### SUMMARY OF THE INVENTION

The present invention has been carried out in view of the above-mentioned circumstances, and it is an object of the present invention to provide a foamed molding that can maintain its product dimensions even when the foamable synthetic resin foams further after molding in a mold device is completed.

In order to achieve the above-mentioned object, in accordance with an aspect of the present invention, there is proposed a foamed molding comprising a skin layer formed by cooling and solidifying a foamable synthetic resin that has been injected into a cavity and a foamed layer formed within the skin layer by foaming the foamable synthetic resin after the skin layer has been formed, wherein the foamed molding further comprises a rod-like connector section formed integrally with the skin layer, the rod-like connector section connecting together parts of the skin layer that correspond to each other so that the foamed layer is interposed between the parts of the skin layer.

In accordance with the foamed molding having the above-mentioned arrangement, since the parts of the skin layer corresponding to each other and having the foamed layer interposed between them are connected together by the rod-like connector section that is integral with the skin layer, if the foamable synthetic resin foams further and the foamed layer attempts to expand after molding in the mold device is completed, expansion of the foamed layer is suppressed by the skin layer connected by the connector section, and the product dimensions of the foamed molding can thus be maintained.

The above-mentioned objects, other objects, characteristics and advantages of the present invention will become apparent from an explanation of a preferred embodiment that will be described in detail below by reference to the attached drawings.

### BRIEF DESCRIPTION OF THE DRAWINGS

FIGS. 1 to 5 illustrate one embodiment of the present invention.

FIG. 1 is a longitudinal cross section of a glove box.

FIG. 2 is an exploded perspective view of the glove box.

FIG. 3 is a perspective view of a foamed molding cross-sectioned at line 3-3 in FIG. 2.

FIG. 4 is a partial longitudinal cross section of a mold device with a synthetic resin injected into it.

FIG. 5 is a partial longitudinal cross section of the mold device at a time when formation of the foamed molding is completed.

### DESCRIPTION OF PREFERRED EMBODIMENTS

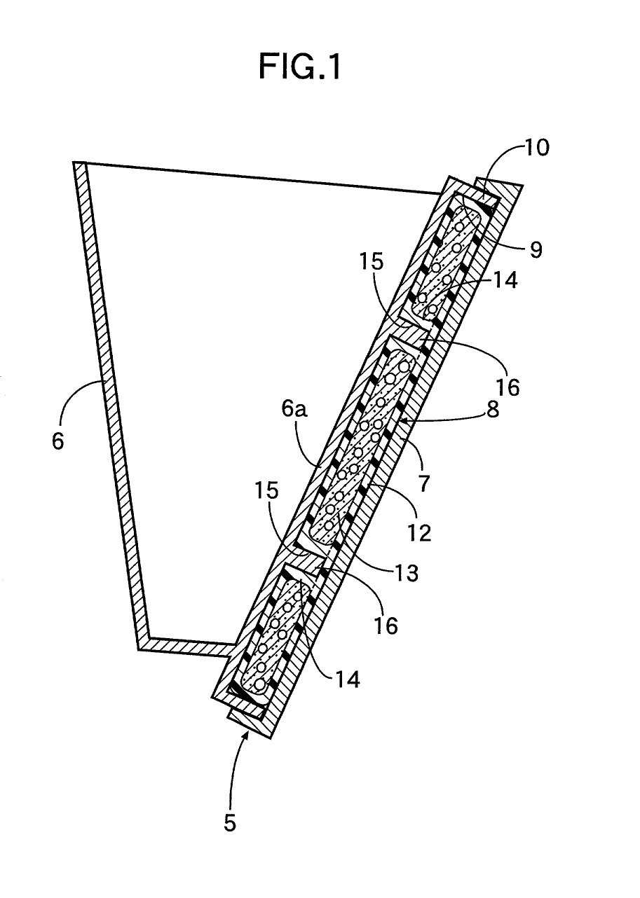

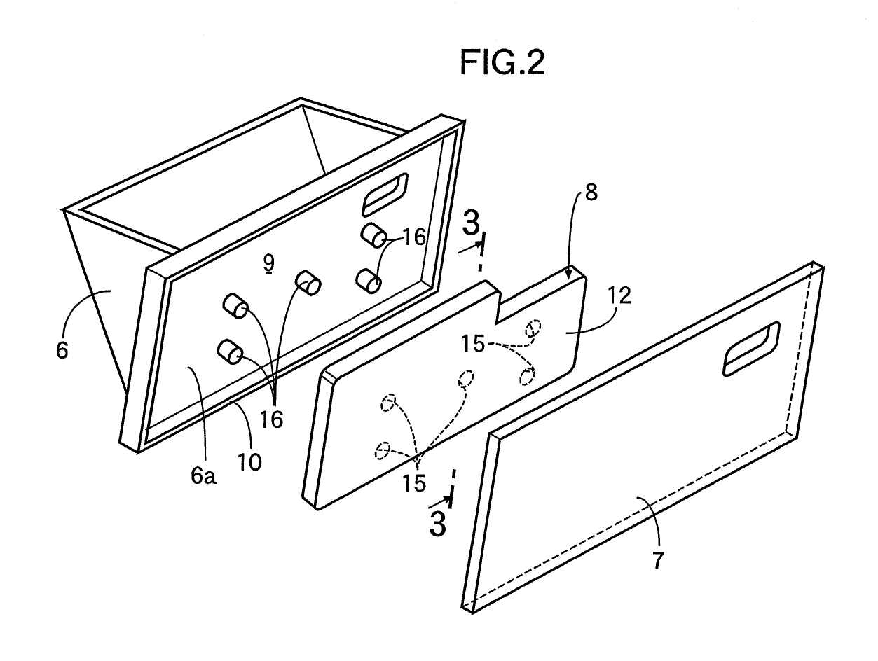

Referring to FIGS. 1 to 5, one embodiment of the present invention is explained below. In FIGS. 1 and 2, a glove box 5 mounted in an instrument panel (not illustrated) of a vehicle has an arrangement in which a box member 6 made of, for example, a synthetic resin and a lid member 7 made of, for example, a synthetic resin are joined together by vibration welding, etc. with a foamed molding 8 interposed between the box member 6 and the lid member 7.

The foamed molding 8 absorbs the impact generated when the knees of an occupant of the vehicle are involved in a secondary collision with the glove box 5 of the instrument panel, and the glove box 5 functions as a knee bolster.

The box member 6 is made of a synthetic resin in the form of a box opening upward having, as one of its walls, a rectangular opposing wall 6a that opposes the lid member 7. On the periphery of the opposing wall 6a is provided an integral joining wall part 10 projecting toward the lid member 7 and forming, together with the opposing wall 6a, a recess 9 opening toward the lid member 7. The periphery of the lid member 7 is joined to the joining wall part 10.

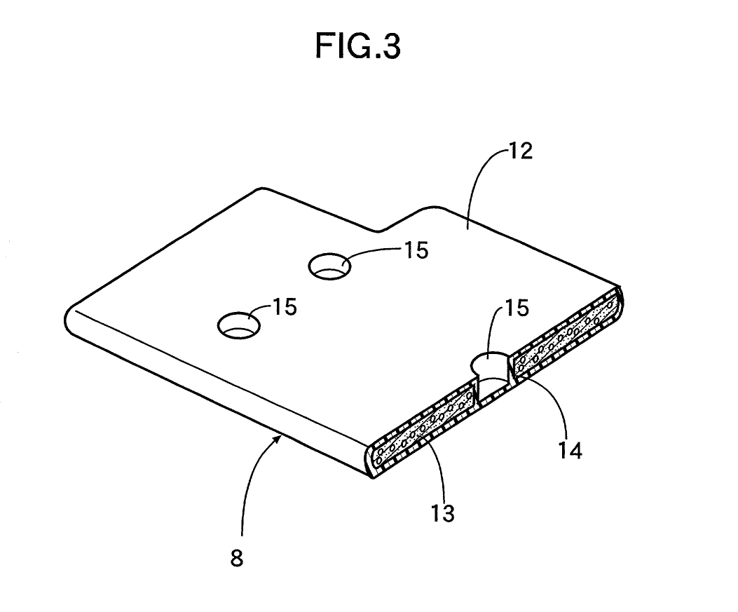

Referring also to FIG. 3, the foamed molding 8 comprises a hard skin layer 12 and a foamed layer 13 formed within the skin layer 12 so as to be wrapped with the skin layer 12, and is interposed between the opposing wall 6a of the box member 6 and the lid member 7 so as to be housed in the recess 9.

Formed at a plurality of points on the skin layer 12 are integral rod-like connector sections 14 that connect together parts of the skin layer 12 that correspond to each other, the foamed layer 13 being interposed between the parts of the skin layer 12. On one surface of the skin layer 12, the surface facing the opposing wall 6a of the box member 6, are provided a plurality of engagement recesses 15 so as to form a void in each of the connector sections 14 on the side facing the box member 6. A plurality of projecting positioning pins 16 provided on the opposing wall 6a of the box member 6 are fitted into the corresponding engagement recesses 15 so as to position the foamed molding 8 which is interposed between the opposing wall 6a of the box member 6 and the lid member 7.

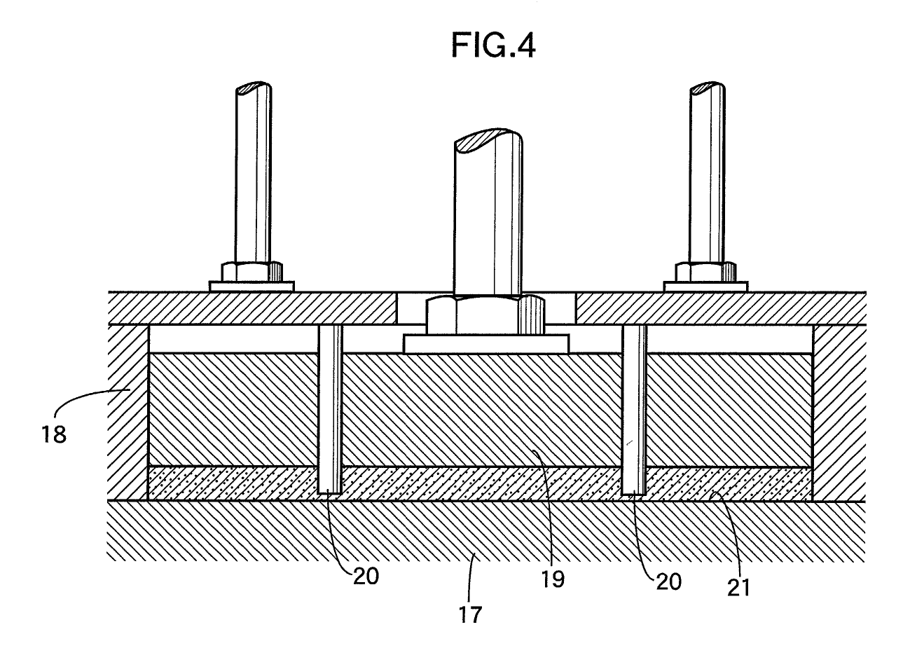

A mold device used for forming the foamed molding 8, as shown in FIG. 4, has first and second molds 17 and 18 that can approach or depart from each other, a slide block 19 forming, together with the first and second molds 17 and 18, a cavity 21, the slide block 19 being slidably supported by the second mold 18 so as to change the capacity of the cavity 21, and a plurality of slide pins 20 passing through the slide block 19 in a relatively movable manner so that the extremities of the slide pins 20 enter the cavity 21, with the base ends of the slide pins 20 being fixed to the second mold 18.

When forming the foamed molding 8 using this mold device, as shown in FIG. 4, the slide block 19 is put close to the first mold 17 so as to reduce the capacity of the cavity 21, and the gap between the extremity of each of the slide pins 20 and the first mold 17 is set at a level corresponding to the thickness of the skin layer 12. In such a state a molten foamable synthetic resin is injected into the cavity 21, and the pressure of the mold device is maintained so that the molten synthetic resin does not foam. In the meantime, the molten resin is cooled and hardened by means of the parts of the mold device that define the cavity 21, that is to say, the surface that is in contact with the first mold 17, the second mold 18, the slide block 19 and the slide pins 20 is formed into the skin layer 12 while the connector sections 14 are formed around the slide pins 20.

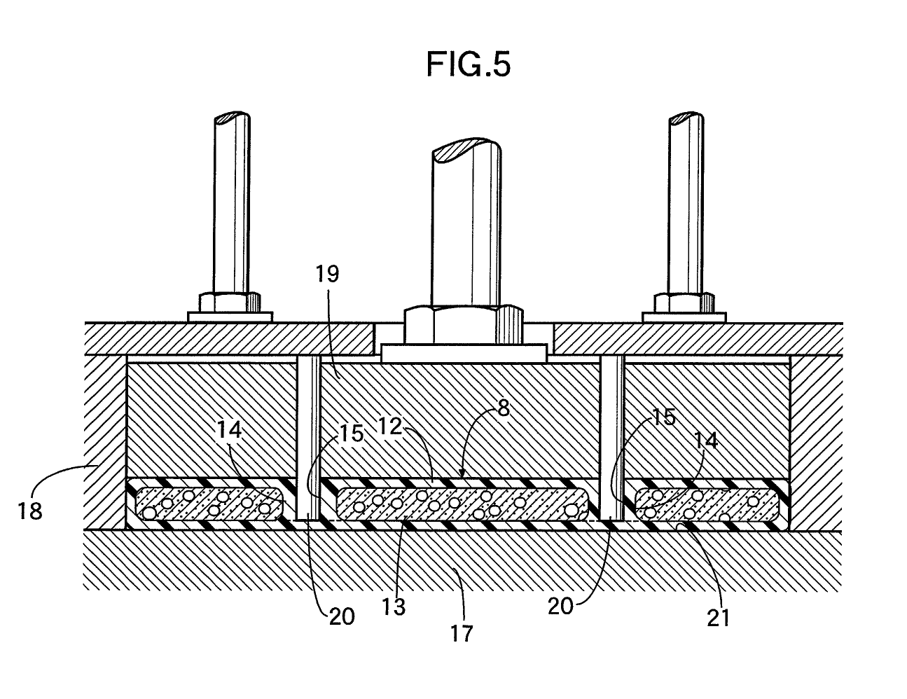

Subsequently, as shown in FIG. 5, sliding the slide block 19 so as to increase the capacity of the cavity 21 allows the molten foamable synthetic resin remaining unhardened within the skin layer 12 to foam in response to a decrease in the pressure of the cavity 21 thus forming the foamed layer 13 within the skin layer 12 to give the foamed molding 8 in which the foamed layer 13 is formed within the skin layer 12 that is bridged by the plurality of the connector sections 14.

After an adequate foaming and cooling time, the completed foamed molding 8 is removed from the mold device, the portions of the connector sections 14 corresponding to the slide pins 20 remain as voids, and these voids function as the above-mentioned engagement recesses 15.

The action of the embodiment is now explained. At a plurality of points on the skin layer 12 of the foamed molding 8 are formed integrally the rod-like connector sections 14 that connect the parts of the skin layer 12 that correspond to each other, the foamed layer 13 formed within the skin layer 12 being interposed between the parts of the skin layer 12. The external shape of the skin layer 12 is firmly maintained by each of the connector sections 14.

It is therefore possible, by connecting the skin layer 12 with the connector sections 14, to suppress expansion of the foamed layer 13 even when the foamable synthetic resin further foams after molding of the foamed molding 8 in the mold device is completed, and the product dimensions of the foamed molding 8 can thus be maintained.

As a result, assembly of the foamed molding 8 with the glove box 5 is not difficult, and the foamed molding 8 can easily be assembled onto a desired position of the glove box 5.

Although an embodiment of the present invention has been explained in detail above, the present invention is in no way limited by the above-mentioned embodiment and can be modified in a variety of ways without departing from the spirit and scope of the present invention described in the appended claims.

What is claimed is:

1. A foamed molding comprising a skin layer formed by cooling and solidifying a foamable synthetic resin that has been injected into a cavity and a foamed layer formed within the skin layer by foaming the foamable synthetic resin after the skin layer has been formed, wherein the foamed molding comprises:
a rod-like connector section formed integrally with the skin layer, the rod-like connector section connecting together parts of the skin layer that correspond to each other with the foamed layer interposed between the parts of the skin layer.
